(19) United States
(12) Patent Application Publication
(10) Pub. No.: US 2005/0252552 A1
(43) Pub. Date: Nov. 17, 2005

(54) Device insertable in a pipeline, with improved capacity for remaining in position

(76) Inventors: Sylvain Pineau, Montegeron (FR); Andre Ohier, Nivallella (FR)

Correspondence Address: McDERMOTT, WILL & EMERY, 2049 Century Park East, 34th Floor, Los Angeles, CA, 90067, US

(21) Appl. No.: 11/126,699

(22) Filed: May 11, 2005

(30) Foreign Application Priority Data
May 11, 2004 (FR) 0405095

(51) Int. Cl. G05D 7/00

(52) U.S. Cl. 137/315.01

(57) ABSTRACT

The invention relates to a device intended to be introduced into a pipeline for circulating a fluid and comprising an operational element, a central connecting rod and a plurality of radial lugs, these lugs being linked to the operational element by means of the connecting rod and extending, under the effect of an elastic force, like umbrella spokes, to press against the inside of the pipeline. According to the invention, the lugs are spaced regularly around a same fitting, and the elastic force is at least partly constituted of a turning torque applied to the lugs through support means constituted, for example, by an axial spring pushing a stop washer mounted to slide on the connecting rod.

### CROSS-REFERENCE To RELATED APPLICATIONS

This application claims priority to French patent application No. 0405095 filed on or about May 11, 2004.

### BACKGROUND OF THE INVENTION

1. Field of Invention

The present invention relates, in general, to techniques for operating pipeline networks, and in particular gas pipelines.

2. Description of the Related Art

More precisely, the invention relates to a device for security, control, measurement and/or monitoring able to be introduced into a pipeline intended for guiding a fluid flow from upstream to downstream, this device comprising an operational element for fulfilling the principal function of the device, a retaining element for maintaining the operational element in position in the pipeline, and a central connecting rod linking the operational element and the retaining element together, the retaining element comprising a plurality of radial lugs spaced regularly around the connecting rod and each having an end linked to the connecting rod as well as a free end, these lugs being elastically stressed in such a direction that they are extended, in the same way as umbrella spokes and against the flow, from a folded position in which these lugs are relatively close to the connecting rod, into an extended position wherein these lugs are pressed against the pipeline and relatively far from the connecting rod because of their respective free ends, while still forming an angle of less than 90 degrees with the connecting rod.

A device of this type, intended to be used for security, is described in particular in the patent application EP 1 388 697 submitted by the same applicant.

Even though its qualities cannot be denied, this known device, wherein the lugs extend by means of their own elasticity, can only provide a blocking force insufficient for resisting the fluid pressure without risk of migration inside the pipeline.

Although a priori one can envisage increasing this blocking force by providing the free ends of the lugs with aggressive profiles adding a higher friction force in the duct, this approach is incompatible with the need for respecting the integrity of the pipe, in particular when the latter is made of polyethylene.

### SUMMARY OF THE INVENTION

In this context, the aim of the invention is to propose a device able to be inserted into a pipeline and to be maintained in position there without damaging the said pipeline.

Thus the device according to the invention, moreover in compliance with the generic definition as described in the above introduction, is essentially characterised in that the retaining element comprises a fitting linked to the connecting rod and support means, such that the lugs are mounted rotationally spaced on the fitting by their respective linked ends around respective articulation axes, and in that each lug receives an elastic force from the support means having at least one active component perpendicular to this lug and applying a rotational torque on this lug that forces it towards its extended position.

As a result of this layout, the retaining element can develop a significant blocking force while still remaining small in size, on the one hand limiting the load loss represented by the device in the pipeline and on the other hand avoiding using claw profiled lugs, that risk damaging the pipeline.

The support means, for example, comprise a stop washer mounted to slide on the connecting rod and sliding pressing on an inside edge of each of the lugs, and a spring with a first end. fixed relative to the connecting rod and with a second end pressing the stop washer elastically against the respective inside edges of the lugs.

The inside edge of each lug can advantageously have a slope variation forming a protuberance circumvented by the stop washer when this lug passes from its folded position to its extended position such that, for a same stop washer displacement, the lugs pivot at a smaller angle before the stop washer reaches the protuberance than when the stop washer has passed round this protuberance.

Preferably, away from its linked end, each lug forms at least one wing, and each wing of each lug possesses, at different distances from the linked end of this lug, different inclinations relative to a plane perpendicular to the articulation axis of this lug, each wing thus adopting the internal shape of the pipeline in the extended lug position.

In practice, it is preferable to envisage that each lug can form two wings symmetrical with each other relative to the plane perpendicular to the articulation axis of this lug.

Each lug, for example, is formed of one or several die cut and folded metallic blanks.

The device according to the invention can also comprise, apart from the fitting relative to the connecting rod, a flexible stop rod having one end linked to the fitting and a free end, this stop rod making it possible to guide the device inside the pipeline and to define the position of the device by stopping it on a predetermined obstacle.

In order to reduce the load loss introduced by the device, the stop rod is preferably terminated by a conical end piece at its free end.

Moreover, in order to avoid any abrupt change in diameter, that might make the device catch on a partial obstacle in the pipeline, it can be useful to ensure that the stop. rod expands gradually at its linked end by widening towards the fitting.

The device according to the invention is applicable in particular to the case where the operational element is constituted of a security valve able to block the pipeline if the fluid flow exceeds a predetermined flow rate.

The invention also relates to a method for placing, in a pipeline, a device such as that described above, this method being characterized in that it comprises a preparatory phase consisting of inserting at least the operational element and the folded lugs of the retaining element into an open end of. a shaft with its opposite end linked to a hollow sleeve and enclosing a power cylinder, an insertion phase consisting of inserting and moving the shaft and its carried device forward into the pipeline, by pushing the sleeve into the pipeline, and a freeing phase consisting, once a determined position of the device has been reached, of ejecting this device from the shaft by feeding the power cylinder through the hollow sleeve.

In the special case where the device is provided with a stop rod and set in position in a gas pipeline comprising a branch pipe and a branch connector, the method according to the invention comprises, before the freeing phase, a phase for determining the device's destined position set by detecting the stop of the stop rod against a transverse partition of the branch connector, the freeing phase then liberating the lugs in the branch pipe.

### BRIEF DESCRIPTION OF DRAWINGS

Other characteristics and advantages of the invention will become clearer from the following description, given as an indicative and non-limiting example, with reference to the attached drawings, in which:

FIG. 1 is an axial cross-section of a device according to the invention, shown before being inserted 15 into a pipeline;

FIG. 2 is an axial cross-section of a device according to the invention, shown after insertion into a pipeline;

FIG. 3 is a side view of part of a device according to the invention;

FIG. 4 is a magnified side view of a metallic blank produced to constitute a lug for a device according to the invention;

FIG. 5 is a magnified front view of a lug of a device according to the invention;

FIG. 6A is a drawing partially representing a device according to the invention, inserted in a pipeline, and whose lugs are in the process of extending;

FIG. 6B is a drawing partially representing a device according to the invention, inserted in a pipeline, with its lugs fully extended;

FIG. 7 is a magnified view in perspective of a fitting used in a device according to the invention;

FIG. 8 is a cross-section of a pipeline in which a device according to the invention is installed, and

FIG. 9 is a drawing partially representing a gas distribution branch line suitable for application of a device according to the invention.

### DETAILED DESCRIPTION OF ILLUSTRATIVE EMBODIMENTS

As stated above, the invention relates to a device intended to be introduced into a pipeline 1 in which a liquid or gaseous fluid is flowing from X−upstream of the position occupied by this device to X+ downstream of this position.

Firstly, this device comprises an operational element 2 capable of fulfilling the principal function of this device, and which, in particular, can fulfill a security, control, measuring and/or monitoring function.

For example, the operational element 2 can be constituted of a security valve able to block the pipeline 1 in the case where the fluid flow exceeds a predetermined flow rate, in particular in the case of a gas pipeline, as described in the above-mentioned patent document EP 1 388 697.

Apart from the operational element 2, the device according to the invention also comprises a retaining element, to be described in detail below, and which acts to maintain the operational element 2 in place in the pipeline 1, and a central connecting rod 6 linking the operational element 2 and the retaining element together.

In ways known to those skilled in the art, this retaining element comprises, in particular, a plurality or radial lugs 3 spaced regularly around the connecting rod 6, each of these lugs 3 having an end 31 linked to the connecting rod 6 and a free end 32.

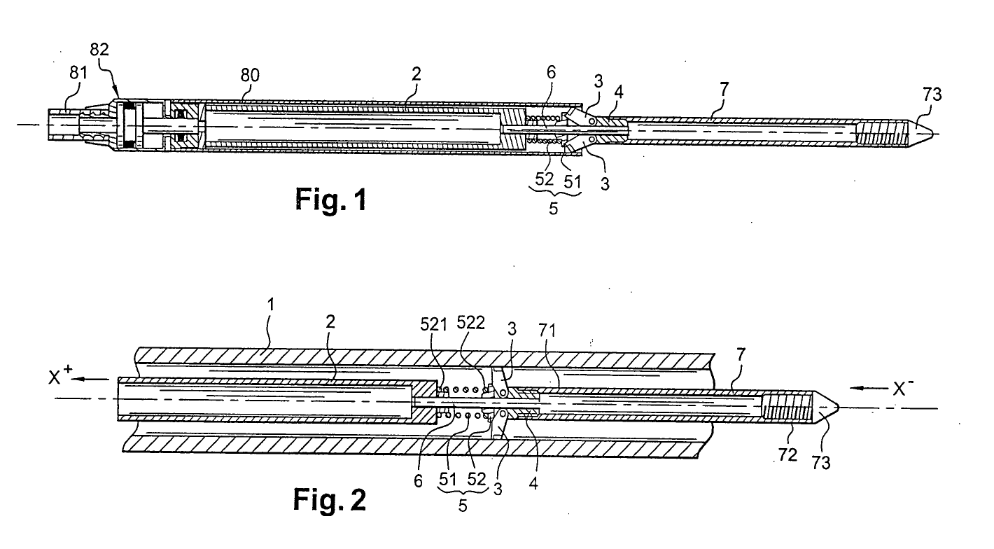

The lugs 3 are elastically drawn in a direction such that they extend, like umbrella spokes and against the flow from X− to X+, from a folded position as seen in FIG. 1 and wherein these lugs 3 are relatively close to the connecting rod 6, to an extended position as seen in FIG. 2.

Even though the angle formed between the connecting rod 6 and the lugs 3 in their extended position remains les than 90 degrees, the respective free ends 32 of the lugs 3, in the extended position of these lugs, are sufficiently far from the connecting rod 6 to be able to press against the inside of the pipeline 1.

According to the invention, the retaining element comprises, apart from lugs 3, a fitting 4 and support means 5.

The fitting 4 is linked to the connecting rod 6 and the lugs 3 are spaced regularly around this fitting 4 by their respective linked ends 31, around respective articulation axes Y.

Moreover, each lug 3 receives an elastic force from the support means 5 wherein at least one active component F (FIGS. 6A and 6B) is perpendicular to this lug 3 and thus applies a rotational torque on this lug 3, drawing it towards its extended position.

Contrary to the patent document EP 1 388 697 mentioned above, the lugs 3 of the device according to the invention are thus submitted to an external elastic force and in addition, according to a layout allowing a high intensity elastic force to be obtained, the lugs 3 no longer themselves need to be made out of an intrinsically elastic material.

The angle formed between the connecting rod 6 and the lugs 3 in extended position is preferably greater than 60 degrees and, even more advantageously, greater than 75 degrees.

As can be seen most clearly from FIGS. 2, 6A and 6B, the support means 5 comprise, for example, a stop washer 51 and a spring 52.

The stop washer 51 is mounted to slide on the connecting rod 6 and slipping while pressed against the internal edge 30 of each one of lugs 3.

The spring 52, working for example in compression, has a first extremity 521 fixed relative to the connecting rod 6, and a second extremity 522 elastically pressing the stop washer 51 against the respective internal edges 30 of the lugs 3.

As shown in FIGS. 4, 6A and 6B, the internal edge 30 of each lug 3 can have a slope variation, this slope variation forming a protuberance 300 circumvented by the stop washer 51 when this lug passes from its folded position to its extended position.

As shown in FIGS. 4 and 5, each lug 3 is made up of one or several metallic blanks die cut and folded, and forming, at a distance from its linked end 31, one or several wings 320.

For example, each lug 3 is made up of two die cut and folded metallic blanks, forming two wings 320 symmetrical with the plane P perpendicular to the articulation axis Y of this lug.

At different distances from the linked end 31 of this lug, each wing 320 has different inclinations relative to the plane P perpendicular to the articulation axis Y of this lug 3.

In the embodiment shown, the changes in inclination are obtained by folding each of the two metallic blanks of each lug 3 along two folds K1 and K2, in symmetrical fashion relative to plane P

Each wing 320 of each lug 3 can thus closely adopt the internal shape of the pipeline 1 in the lug's extended position, as shown in FIG. 8.

As can be seen in FIGS. 1 to 3, the device according to the invention also comprises a flexible stop rod 7 having one end, 71 linked to the fitting 4 and a free end 72, set at the opposite end from the operational element 2 and terminated by a conical end piece 73 to reduce load losses.

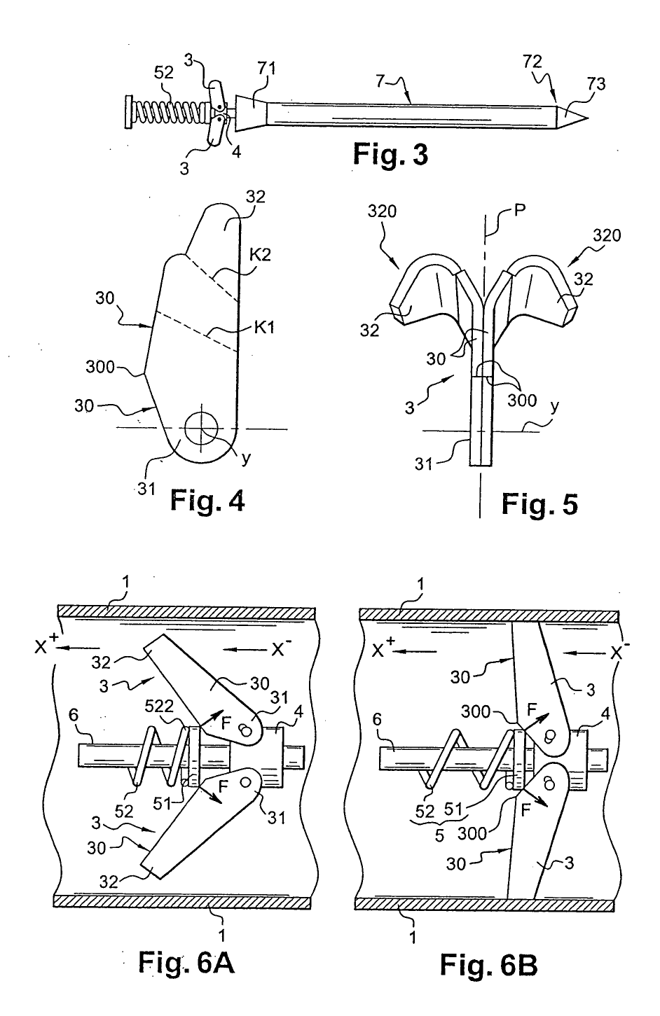

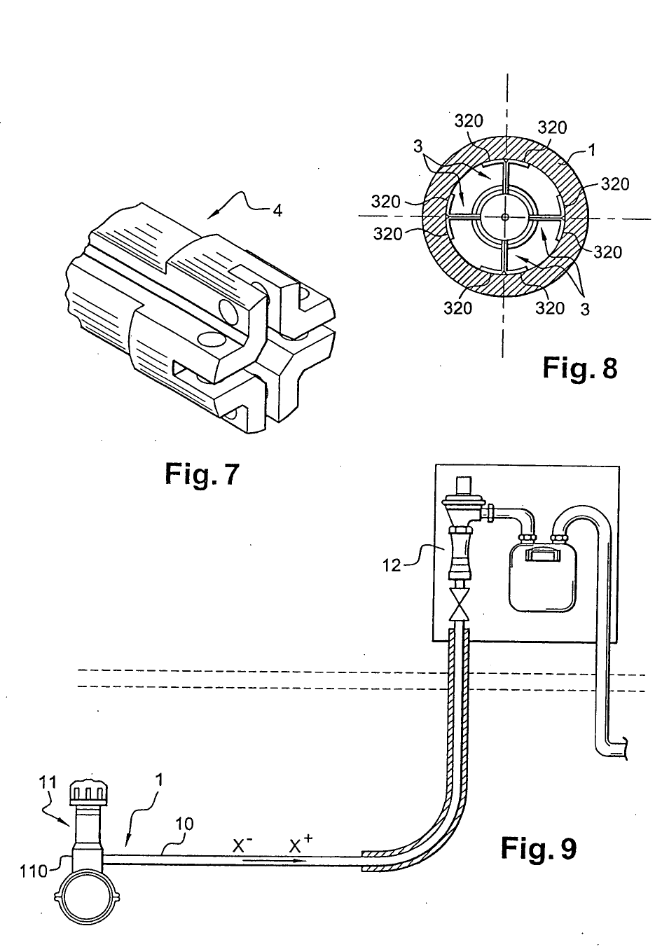

At its linked end 71, the stop rod 7 (FIG. 3) can carry a tapered ring so as to widen progressively, opening towards the fitting 4, this progressive change in diameter assisting the device when encountering obstacles.

The positioning of the device in the pipeline is carried out, as described in the above- mentioned patent document EP 1 388 697, by means of a flexible strip with one end carrying a shaft (80) FIG. 1 transporting the device as far as its insertion position in the pipeline.

According to the invention, the setting tool is further improved by adding a power cylinder 82 set in the base of the shaft 80, and by adding a hollow sleeve 81 opening into the cylinder capable of carrying a power cylinder 82 feed fluid.

The method for placing the device in a pipeline 1 will be described below with reference to FIGS. 1 and 9, the latter representing a gas distribution installation.

Such an installation typically comprises a branch connector 11 feeding gas into a branch box 12 through a branch pipe 10 which in this case constitutes the pipeline 1.

First of all, the device's operational element 2 and lugs 3, set in folded position, are introduced into the open end of the shaft 80, such that consequently only the stop rod 7 remains outside.

The assembly constituted by the sleeve 81, the power cylinder 82, the shaft 80 and the device is pushed into the branch pipe 10 in the direction of the branch connector 11, for example from the branch tap through the intermediary of a chamber gland allowing intervention while under charge.

When the conical end piece 73 comes up against the transverse wall 110 of the branch connector 11, the increase in force needed for the assembly to progress further into the pipeline 1 indicates that the device has reached its destination.

The power cylinder 82 is then fed by injecting drive fluid in the sleeve 81, which results in the device being freed outside the shaft 80.

As soon as the lugs 3 leave this shaft, they extend in the branch pipe 10, just downstream from the branch connector 11, to take up their definitive position shown in FIG. 2.

1. A device for security, control, measurement and/or monitoring able to be introduced into a pipeline intended for guiding a fluid flow from upstream (X−) to downstream (X+), this device comprising:
an operational element able to fulfill the principal function of the device, a retaining element for maintaining the operational element in position in the pipeline, and a central connecting rod linking the operational element and the retaining element together, the retaining element comprising a plurality of radial lugs spaced regularly around the connecting rod and each having an end linked to the connecting rod as well as a free end, these lugs being elastically stressed in a direction such that they are extended, in the same way as umbrella spokes and against the flow, from a folded position in which these lugs are relatively close to the connecting rod, into an extended position where these lugs are pressed against the pipeline and relatively far from the connecting rod at their respective free ends while still forming an angle of less than 90 degrees with the connecting rod, characterised in that the retaining element comprises a fitting linked to the connecting rod and support means, in that the lugs are mounted rotationally spaced on the fitting by their respective linked ends around respective articulation axes (Y), and in that each lug receives an elastic force from the support means having at least one active component (F) perpendicular to this lug and applying a rotational torque on this lug drawing it towards its extended position.

2. Device according to claim 1, characterised in that the support means comprise a stop washer mounted to slide on the linking rod and slipping pressing on an inside edge of each of the lugs, and a spring with one end fixed relative to the linking rod and with a second end pressing the stop washer elastically against the respective inside edges of the lugs.

3. Device according to claim 2, characterised in that the inside edge of each lug has a slope variation forming a protuberance circumvented by the stop washer when this lug passes from its folded position to its extended position.

4. Device according to either one of claims 2 or 3, characterised in that each lug forms, away from its linked end, at least one wing, and in that each wing of each lug possesses, at different distances from the linked end of this lug, different inclinations relative to a plane (P) perpendicular to the articulation axis (Y) of this lug, each wing thus adopting the internal shape of the pipeline in the lug extended position.

5. Device according to claim 4, characterised in that each lug forms two wings, symmetrical with each other relative to the plane (P) perpendicular to the articulation axis (Y) of this lug.

6. Device according to claim 1, characterised in that each lug is formed of at least one die cut and folded metallic blank.

7. Device according to claim 1, characterised in that it comprises, apart from the fitting relative to the connecting rod, a flexible stop rod having one end linked to the fitting and a free end.

8. Device according to claim 7, characterised in that the stop rod is, at its free end terminated by a conical end piece.

9. Device according to either one of claims 7 or 8, characterised in that the stop rod expands gradually at its linked end widening towards the fitting.

10. Device according to claim 1, characterised in that the operational element is constituted by a security valve able to block the pipeline in the case where the fluid flow exceeds a predetermined flow rate.

11. A method for placing, in a pipeline, a device for security, control, measurement and/or monitoring, characterised in that it comprises:
providing a device for security, control, measurement and/or monitoring that includes:
an operational element able to fulfill the principal function of the device,
a retaining element for maintaining the operational element in position in the pipeline, and
a central connecting rod linking the operational element and the retaining element together,
wherein the retaining element comprises a plurality of radial lugs spaced regularly around the connecting rod and each having an end linked to the connecting rod as well as a free end, these lugs being elastically stressed in a direction such that they are extended, in the same way as umbrella spokes and against the flow, from a folded position in which these lugs are relatively close to the connecting rod, into an extended position where these lugs are pressed against the pipeline and relatively far from the connecting rod at their respective free ends while still forming an angle of less than 90 degrees with the connecting rod, characterised in that the retaining element comprises a fitting linked to the connecting rod and support means, in that the lugs are mounted rotationally spaced on the fitting by their respective linked ends around respective articulation axes (Y), and in that each lug receives an elastic force from the support means having at least one active component (F) perpendicular to this lug and applying a rotational torque on this lug drawing it towards its extended position.
a preparatory phase including inserting at least the operational element and the folded lugs of the retaining element into an open end of a shaft with an opposite end linked to a hollow sleeve and enclosing a power cylinder;
an insertion phase including inserting and moving the shaft and the device it carries, forward into the pipeline, by pushing the sleeve into the pipeline and
a liberating phase including, once a destined position of the device has been reached, ejecting this device from the shaft by feeding the power cylinder through the hollow sleeve.

12. A method according to claim 11 for putting a device for security, control, measurement and/or monitoring into place in a gas pipeline, the method further comprising: before the liberating phase, a phase for determining the destination position of the device implemented by detecting the stop of the stop rod against a transversal partition of the branch connector and wherein the liberating phase then frees the lugs in the branch pipe and; wherein the device for security control, measurement and/or monitoring further comprises apart from the fitting relative to the connecting rod, a flexible stop rod having one end linked to the fitting and a free end, and wherein the gas pipeline includes a branch pipe and a branch connector.
